(19) United States
(12) Patent Application Publication
(10) Pub. No.: US 2014/0154534 A1
(43) Pub. Date: Jun. 5, 2014

(54) POWER BATTERY SAFETY HEAD COVER

(71) Applicant: NINGDE AMPEREX TECHNOLOGY LIMITED, Ningde City (CN)

(72) Inventors: Xiaolei Liu, Ningde City (CN); Pinghua Deng, Ningde City (CN); Peng Wang, Ningde City (CN); Yanhua Lu, Ningde City (CN); Junzhong Hu, Ningde City (CN)

(73) Assignee: NingDe Amperex Technology Limited, Ningde City (CN)

(21) Appl. No.: 13/773,804

(22) Filed: Feb. 22, 2013

(30) Foreign Application Priority Data
Nov. 30, 2012 (CN) 201220647541.X

(51) Int. Cl. H01M 2/04

(52) U.S. Cl. CPC H01M 2/04; H01M 2/0404; H01M 2/043
USPC 429/53

(57) ABSTRACT

The invention pertains to the field of power battery technology, in particular to a power battery safety head cover, comprising a cover plate, a positive pole, a negative pole, a pressure release valve and a filling hole, wherein the positive pole, the negative pole, the pressure release valve and the filling hole are arranged on the cover plate, the positive pole is electrically connected with the cover plate, the negative pole is assembled with the cover plate in an insulating way, and the negative pole is connected with a negative temperature coefficient thermistor.

### FIELD OF THE INVENTION

The invention pertains to the field of power battery technology, in particular to a power battery safety head cover with a safety protection function.

### BACKGROUND OF THE INVENTION

With development of modern society and strengthening of environmental protection consciousness, more and more devices can be equipped with selectable and rechargeable secondary batteries as power supply thereof, such as mobile phones, notebook computers, power tools, electric automobiles and so on, which provides broad space for application and development of rechargeable secondary batteries.

Electric automobiles and storage power stations generally need power batteries of large capacity as power supply thereof. These power batteries are characterized by high power capacity, good safety and longer cycle life etc., so as to meet usage criteria and users' demands.

Generally, a pressure release valve is installed on the power battery safety head cover in order to guarantee safety thereof to some extent.

Once an accident occurs in a battery when it is subject to improper battery charging, short circuit or exposure to high temperature and other severe environment, the high energy battery may produce a large amount of gas, with the temperature rising sharply; the gas bursts through the pressure release valve, thus the purpose of pressure release is reached. The pressure release valve can improve safety performance of the battery to a certain extent. However, a malfunctioning battery itself constitutes a hidden danger because of failure of release of energy accumulated; furthermore, overcharge of a malfunctioning battery may result in larger security accidents.

People adopt various safety precautions for the power battery head cover in order to solve the safety problem thereof, for example, on the battery head cover is provided with a indentation, a safety valve, a tilting piece and a rupture membrane etc., which are neither timely nor accurate for control of temperature rise resulted from overcharge, besides, both structure and manufacturing process thereof are relatively complex.

For this reason, it is necessary to provide a power battery head cover with safety protection function. The power battery head cover, with simple structure and manufacturing process, can timely and accurately control temperature rise resulted from overcharge.

### SUMMARY OF THE INVENTION

The invention aims at, in allusion to disadvantages of the prior art, providing a power battery head cover with safety protection function, which not only has simple structure and manufacturing process, but also can timely and accurately control temperature rise resulted from overcharge, so as to overcome the disadvantages of the prior art, in which the power battery head cover is neither timely nor accurate for control of temperature rise resulted from overcharge, besides, both structure and manufacturing process thereof are relatively complex.

For achieving the above-mentioned objectives, the invention adopts a technical scheme as below:

A power battery safety head cover, comprising a cover plate, a positive pole, a negative pole, a pressure release valve and a filling hole, wherein the positive pole, the negative pole, the pressure release valve and the filling hole are arranged on the cover plate, the positive pole is electrically connected with the cover plate, the negative pole is assembled with the cover plate in an insulating way, and the negative pole is connected with a negative temperature coefficient thermistor.

As an improvement of the power battery safety head cover provided by the invention, the negative temperature coefficient thermistor is installed in the negative pole.

As an improvement of the power battery safety head cover provided by the invention, the negative temperature coefficient thermistor is welded, clamped or adhered in the negative pole.

As an improvement of the power battery safety head cover provided by the invention, the cover plate is shaped like a rectangle, a round or an oval.

As an improvement of the power battery safety head cover provided by the invention, the positive pole is conductively connected (welded or riveted) with the cover plate.

As an improvement of the power battery safety head cover provided by the invention, the negative pole is assembled with the cover plate in an injection moulding and insulating way.

Compared with the prior art, in the invention, the negative pole is connected to the negative temperature coefficient thermistor (NTC), the NTC has a resistance value of about one megohm at a temperature of below 80 DGE C, the resistance value of the NTC is subject to an abrupt drop (only about 100 milliohm) once temperature reaches 80 DGE C (for example, temperature rise resulted from overcharge of a battery etc), which leads to conductance of the positive pole and the negative pole, at this time, the self-discharge current is larger than the charging current, thus discontinuing overcharge, keeping the battery system at a discharge condition, and avoiding out of control of the battery resulted from accumulation of heat. To sum up, by taking advantage of operating feature of the NTC, the invention has the advantage of preventing the battery from thermal runaway resulted from overcharge and of protecting the battery. In addition, the invention has the advantages of simple structure and manufacturing process and good technological control, an extra thermistor support device is needless. The resistance value of NTC is subject to an abrupt drop in case of overcharge of a battery. The invention is sensitive and accurate, capable of discontinuing overcharge, thereby guaranteeing safety of the battery.

### BRIEF DESCRIPTION OF THE DRAWINGS

FIG. 1 is a solid diagram of the invention; and

FIG. 2 is a stereoscopic section view of FIG. 1 split along a-a line.

### DETAILED DESCRIPTION OF THE EMBODIMENTS

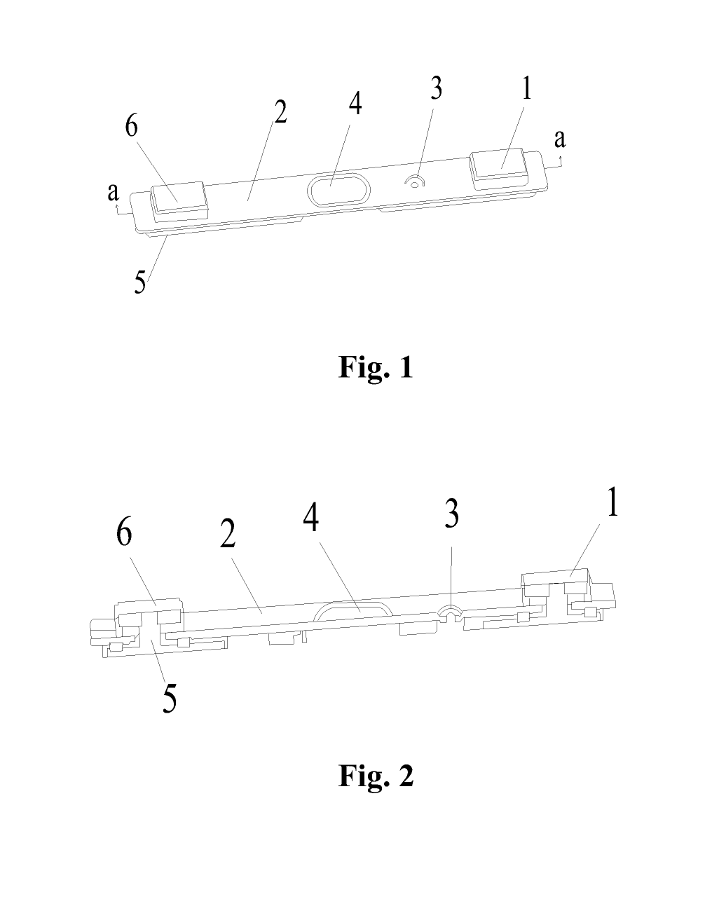

As shown in FIG. 1 and FIG. 2, the invention provides a power battery safety head cover, comprising a cover plate 2, a positive pole 1, a negative pole 6, a pressure release valve 4 and a filling hole 3, wherein the positive pole 1, the negative pole 6, the pressure release valve 4 and the filling hole 3 are arranged on the cover plate 2, the positive pole 1 is electrically connected with the cover plate 2, the negative pole 6 is assembled with the cover plate 2 in an insulating way, and the negative pole 6 is connected with a negative temperature coefficient thermistor 5. The negative temperature coefficient thermistor 5 refers to a thermistor with negative temperature coefficient, whose resistance value reduces exponentially with the temperature rise. The thermistor is a semiconductor ceramic resistor made from two or even more metallic oxides (for example, manganese oxide, copper oxide, silicon oxide, cobalt oxide, iron oxide, nickel oxide and zinc oxide etc.) by intensive mixing, molding and sintering processes etc. All these metallic oxides have nature of semiconductors, similar to germanium oxide, silicon oxide and other semiconductor materials in terms of conductance mode. Current carriers in the metallic oxides are few at a low temperature, hence the resistance value thereof is higher. However, the resistance value reduces with temperature rise because number of current carriers increases.

Wherein, the negative temperature coefficient thermistor 5 is installed in the negative pole 6.

The negative temperature coefficient thermistor 5 is welded, clamped or adhered in the negative pole 6; this installation mode is simple in process and good in control.

The cover plate 2 is shaped like a rectangle, a round or an oval. The cover plate 2 with different shapes is suitable for different power batteries, for example, a rectangular power battery and a cylindrical power battery etc.

The positive pole 1 is conductively connected (welded or riveted) with the cover plate 2, that is to say, the positive pole 1 is electrically conductive with the cover plate 2.

The negative pole 6 is assembled onto the cover plate 2 in an injection moulding and insulating way, that is to say, generally the negative pole 6 is electrically insulated with the cover plate 2. However, when temperature rises due to overcharge of a battery, the resistance value of the negative temperature coefficient thermistor 5 is subject to an abrupt drop, which leads to electric conductance of the cover plate 2 with both the positive pole 1 and the negative pole 6, that is to say, the positive pole 1 is subject to electrical conductance to the negative pole 6, at this time, the self-discharge current is larger than the charging current, thus discontinuing overcharge, keeping the battery system at a discharge condition, and avoiding out of control of the battery resulted from accumulation of heat.

To sum up, in the invention, the negative pole 6 is connected to the negative temperature coefficient thermistor 5 (NTC), the NTC has a resistance value of about one megohm at a temperature of below 80 DGE C, the resistance value of the NTC is subject to an abrupt drop (only about 100 milliohm) once temperature reaches 80 DGE C, which leads to conductance of the positive pole 1 and the negative pole 6, at this time, the self-discharge current is larger than the charging current, thus discontinuing overcharge, keeping the battery system at a discharge condition, and avoiding out of control of the battery resulted from accumulation of heat. To sum up, by taking advantage of operating feature of the negative temperature coefficient thermistor 5, the invention has the advantage of preventing the battery from thermal runaway resulted from overcharge and of protecting the battery. In addition, the invention has the advantages of simple structure and manufacturing process and good technological control, an extra thermistor support device is needless. The resistance value of the negative temperature coefficient thermistor 5 (NTC) is subject to an abrupt drop in case of overcharge of a battery. The invention is sensitive and accurate, capable of discontinuing overcharge, thereby guaranteeing safety of the battery.

From above description, those skilled in the art can change or modify the above-mentioned embodiments. Therefore, the invention is not limited to the above-mentioned embodiments. Some modification and alteration of the invention made by those skilled in the art are within the scope of protection of the claims in the invention. In addition, some specific terms are used in the specification for the convenience of description, but not to limit the invention.

What is claimed is:

1. A power battery safety head cover, comprising a cover plate (2), a positive pole (1), a negative pole (6), a pressure release valve (4) and a filling hole (3), wherein the positive pole (1), the negative pole (6), the pressure release valve (4) and the filling hole (3) are arranged on the cover plate (2), the positive pole (1) is electrically connected with the cover plate (2), the negative pole (6) is assembled with the cover plate (2) in an insulating way, and the negative pole (6) is connected with a negative temperature coefficient thermistor (5).

2. The power battery safety head cover of claim 1 wherein the negative temperature coefficient thermistor (5) is installed in the negative pole (6).

3. The power battery safety head cover of claim 2 wherein the negative temperature coefficient thermistor (5) is welded, clamped or adhered in the negative pole (6).

4. The power battery safety head cover of claim 1 wherein the cover plate (2) is shaped like a rectangle, a round or an oval.

5. The power battery safety head cover of claim 1 wherein the positive pole (1) is conductively connected (welded or riveted) onto the cover plate (2).

6. The power battery safety head cover of claim 1 wherein the negative pole (6) is assembled onto the cover plate (2) in an injection moulding and insulating way.
